(19) United States
(12) Patent Application Publication
(10) Pub. No.: US 2009/0027914 A1
(43) Pub. Date: Jan. 29, 2009

(54) Structure for a center high mounted stop lamp

(76) Inventor: Chia-Yeh Wu, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/878,668

(22) Filed: Jul. 26, 2007

(51) Int. Cl. F21V 8/00

(52) U.S. Cl. 362/555

(57) ABSTRACT

The present invention discloses a structure for a center high mounted stop lamp, which comprises: a light pipe, a housing and LEDs. The light pipe has an inorganic light guide coating on a lateral side thereof and has LEDs at both ends thereof. The housing covers the light pipe and has a light reflection layer. The light reflection layer is arranged around the light pipe and behind the inorganic light guide coating. The light emitted by LEDs is scattered by the light pipe and reflected by the inorganic light guide coating. Thus, the light pipe can uniformly emit light. Further, the light emitted by the light pipe is concentrated and reflected out by the light reflection layer. Thereby, the present invention can decrease the number of required LEDs, save power, prolong the service life of LEDs and promote economic efficiency.

### BACKGROUND OF THE INVENTION

1. Field of the Invention

The present invention relates to an illumination device, particularly to a structure for a cost- and energy-efficient center high mounted stop lamp.

2. Description of the Related Art

LED (Light-Emitting Diode) is free of glass, mercury or any toxic gas and has the advantages of superior reliability, high response speed, long service life, and environmental friendliness. When used as a center high mounted stop lamp (CHMSL), LED can enhance driving safety and reduce maintenance expense. LED is a point light source. In the first generation LED CHMSL, as many as 76 red light LEDs can reach the performance of only 2 or 3 incandescent lamps, which makes LED lack cost advantage then. In the second generation LED CHMSL, the number of LED was reduced to 48. The current technology has advanced to such an extent that the number of LEDs has been reduced to 10-20. Refer to FIG. 1 for a conventional CHMSL structure 10, which uses more than ten LEDs (14, 16) as the light source. In comparison with an incandescent lamp, LED can neither generate nor tolerate much heat. High temperature will shorten the service life of LED. If the LEDs used in a CHMSL are too dense or too many, the life cycle of LEDs will be inevitably shortened. When a first LED 14 malfunctions, a second LED 16 can still emit light. However, the brightness of the CHMSL structure 10 will lose uniformity thereby.

Accordingly, the present invention proposes a CHMSL structure to overcome the abovementioned problems.

### SUMMARY OF THE INVENTION

The objective of the present invention is to provide a structure for a center high mounted stop lamp, which can uniformly emit light via utilizing a few LEDs, a light pipe coated with an inorganic light guide coating, and a housing having a light reflection layer, and whereby the number of LEDs is decreased, the power consumption is reduced, the service life of LED is prolonged, and the economic efficiency is promoted.

To achieve the abovementioned objective, the present invention proposes a structure for a center high mounted stop lamp, which comprises: a light pipe having LEDs at both ends thereof and a housing covering the light pipe. The lateral side of the light pipe has an inorganic light guide coating. The housing has a light reflection layer and is connected with two ends of the light pipe. The light reflection layer is arranged around the light pipe and behind the inorganic light guide coating. The light emitted by the LEDs is scattered out by the light pipe and reflected out by the inorganic light guide coating and the light reflection layer.

Below, the embodiments are described in detail in cooperation with the attached drawings to make easily understood the objectives, technical contents, characteristics and accomplishments of the present invention.

### BRIEF DESCRIPTION OF THE DRAWINGS

FIG. 1 is a perspective view of a conventional CHMSL structure;

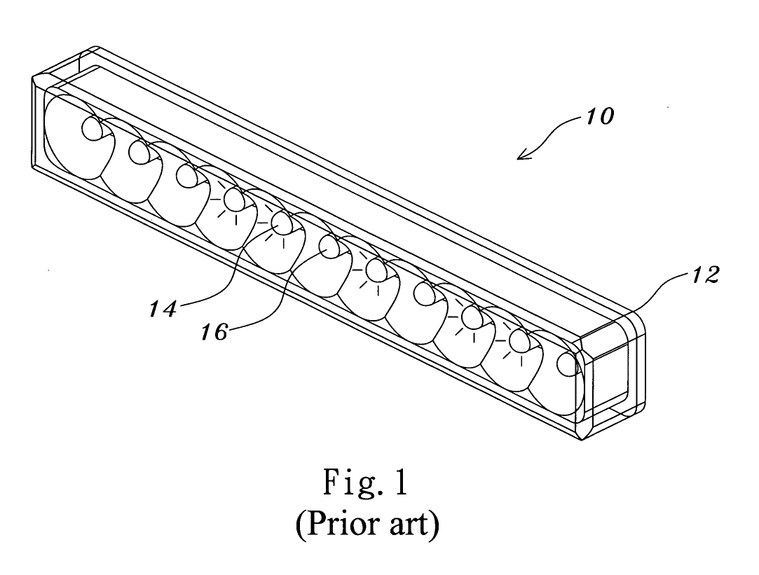

FIG. 2 is a perspective view schematically showing a CHMSL structure according to the present invention;

FIG. 3 is an exploded view schematically showing a CHMSL structure according to the present invention; and

FIG. 4 is a sectional view schematically showing a CHMSL structure according to the present invention.

### DETAILED DESCRIPTION OF THE INVENTION

The present invention proposes a structure for a center high mounted stop lamp (CHMSL), which can fully exploit LED (Light-Emitting Diode) to uniformly emit light via utilizing a housing having a light reflection layer and a light pipe having an inorganic light guide coating on the lateral side thereof and LEDs on both ends thereof.

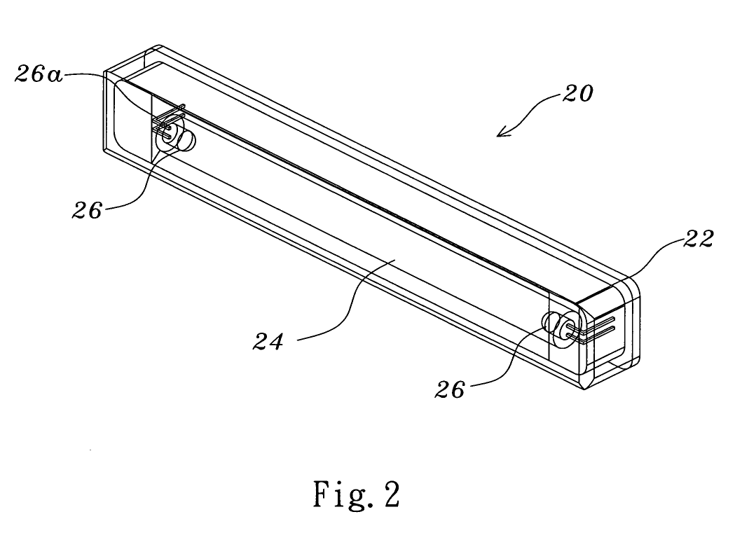

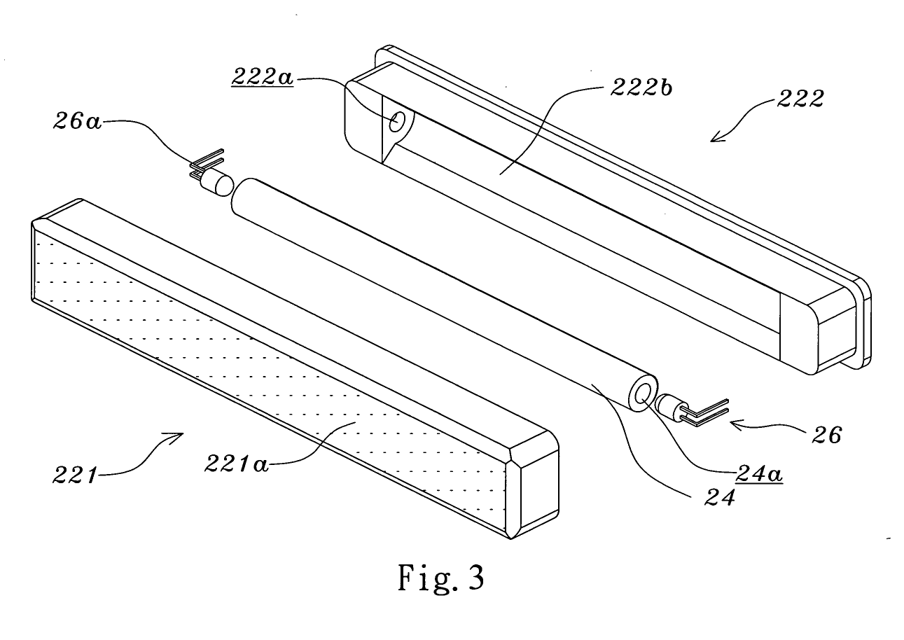

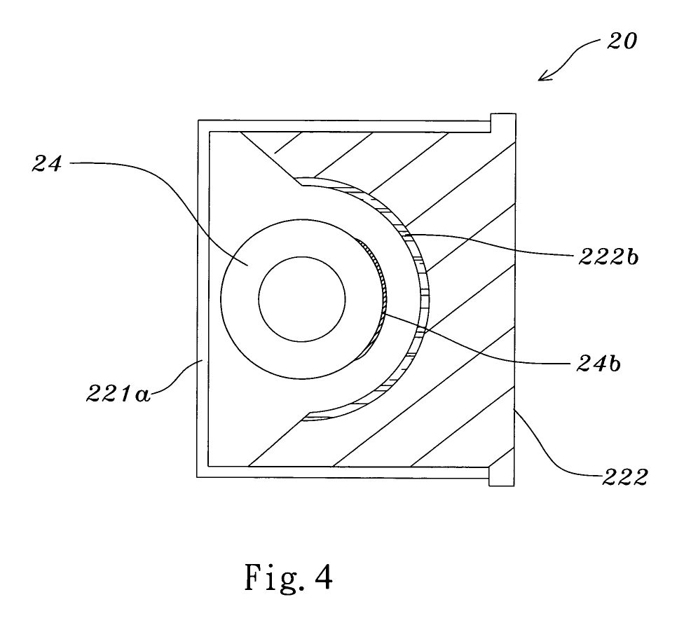

Refer to FIG. 2, FIG. 3 an d FIG. 4. The CHMSL structure 20 of the present invention comprises: a housing 22, a light pipe 24 and LEDs 26. The housing 22 and the light pipe 24 are elongated structures. The housing 22 is formed of an upper hood 221 and a lower casing 222, which are press-fitted to each other. The light pipe 24 is made of a transparent plastic material and arranged inside the housing 22, and two ends of the light pipe 24 are respectively coupled to two ends of the lower casing 222. Two ends of the light pipe 24 have inlay portions 24a where LEDs 26 will be inlayed. Two ends of the lower casing 222 have openings 222a; the leads 26a of LEDs 26 will pass through the openings 222a and then connect with a power source (not shown in the drawings). Besides, the lateral side of the light pipe 24 has an inorganic light guide coating 24b, and the inner face of the lower casing 222 has a light reflection layer 222b arranged around the light pipe 24 and behind the inorganic light guide coating 24b. Further, the upper hood 221 has a light-permeable face 221 a on the front thereof.

The light emitted by the LEDs 26 is scattered by the light pipe 24 and reflected by the inorganic light guide coating 24b, and the light pipe 24 thus uniformly emits light. The light emitted by the light pipe 24 is concentrated and reflected by the light reflection layer 222b and then given off from the light-permeable face 221a. Thereby, the CHMSL structure 20 of the present invention can uniformly emit light via using only a few LEDs 26. Therefore, the present invention can decrease the number of required LEDs and save energy.

The center high mounted stop lamp is usually mounted in the center of the back of a vehicle, such as the trunk hood. CHMSL will be activated for driving safety when the driver pushes the brake pedal. Similar to the conventional CHMSL adopting LEDs, the CHMSL structure 20 of the present invention can also be fast activated. Further, the CHMSL structure 20 of the present invention can uniformly emit light via using only a few LEDs 26. Therefore, the present invention can solve the conventional problem of uneven brightness caused by some malfunctioning LEDs. Thus, the present invention can prevent other drivers from mistaking.

The embodiments described above are only to demonstrate the present invention to enable the persons skilled in the art to understand, make and use the present invention. However, it is not intended to limit the scope of the present invention. Any equivalent modification or variation according to the spirit of the present invention is to be also included within the scope of the present invention.

What is claimed is:

1. A structure for a center high mounted stop lamp comprising:
a light pipe having an inorganic light guide coating on a lateral side thereof;
at least two light-emitting diodes respectively arranged at two ends of said light pipe, wherein said light pipe uniformly emit light via that light emitted by said light-emitting diodes is scattered by said light pipe and reflected by said inorganic light guide coating; and
a housing covering said light pipe, connecting with two ends of said light pipe and having a light reflection layer that is arranged around said light pipe and behind said inorganic light guide coating and is used to concentrate and reflect out light emitted by said light pipe.

2. A structure for a center high mounted stop lamp according to claim 1, wherein said housing is an elongated structure.

3. A structure for a center high mounted stop lamp according to claim 1, wherein said light pipe is an elongated structure.

4. A structure for a center high mounted stop lamp according to claim 1, wherein said light pipe is made of a transparent plastic material.
